(19) United States
(12) Patent Application Publication
(10) Pub. No.: US 2018/0300017 A1
(43) Pub. Date: Oct. 18, 2018

(54) DISPLAY DEVICE AND METHOD OF CONTROLLING DISPLAY DEVICE

(71) Applicant: SEIKO EPSON CORPORATION, Tokyo (JP)

(72) Inventor: Shingo WAKIMOTO, Azumino-shi (JP)

(73) Assignee: SEIKO EPSON CORPORATION, Tokyo (JP)

(21) Appl. No.: 15/950,240

(22) Filed: Apr. 11, 2018

(30) Foreign Application Priority Data
Apr. 17, 2017 (JP) 2017-081133

(51) Int. Cl. G06F 3/042; G06F 3/041

(52) U.S. Cl. CPC G06F 3/0421; G03B 21/006; G06F 3/0416

(57) ABSTRACT

A projector includes a projection section adapted to display an image in a projection area of a screen, a light emission device provided with a first light source section and a second light source section adapted to emit infrared light along the projection area, a pointing body detection section adapted to detect reflected light of infrared light emitted by at least one of the first light source section and the second light source section, and an output control section adapted to adjust an output of the infrared light emitted by at least one of the first light source section and the second light source section in accordance with an installation condition of the light emission device.

### BACKGROUND

### 1. Technical Field

The present invention relates to a display device and a method of controlling the display device.

### 2. Related Art

In the past, there has been known a device for performing irradiation with detection light along a display surface on which an image is displayed, then detecting reflected light of the detection light reflected by a pointing body for pointing a certain position in the display surface to detect the position in the display surface pointed by the pointing body (see, e.g., JP-A-2014-149643).

Incidentally, there can be cited a variety of conditions as an installation condition of the display device. Therefore, in order to accurately detect the pointing position by the pointing body, it is necessary for an output of the irradiation device for performing the irradiation with the detection light to be optimally adjusted in accordance with the installation condition of the display device.

### SUMMARY

An advantage of some aspects of the invention is to adjust the output of the irradiation device in accordance with the installation condition of the irradiation device to thereby improve the detection accuracy of the pointing position.

A display device according to an aspect of the invention includes a display section adapted to display an image on a display surface, an irradiation device provided with a first irradiation section and a second irradiation section each emitting detection light along the display surface, a detection section adapted to detect reflected light of the detection light emitted by at least one of the first irradiation section and the second irradiation section, and an adjustment section adapted to adjust an output of the detection light emitted by at least one of the first irradiation section and the second irradiation section in accordance with an installation condition of the irradiation device.

According to the aspect of the invention, the output of the detection light emitted by at least one of the first irradiation section and the second irradiation section is adjusted by the adjustment section in accordance with the installation condition of the irradiation device. Therefore, it is possible to optimally adjust the output of the irradiation device in accordance with the installation condition of the irradiation device to improve the detection accuracy of the pointing position.

The display device according to the aspect of the invention may further include a determination section adapted to determine the installation condition of the irradiation device, and the adjustment section may adjust the output of the detection light emitted by at least one of the first irradiation section and the second irradiation section in accordance with the installation condition of the irradiation device determined by the determination section.

According to the aspect of the invention with this configuration, the installation condition of the irradiation device can be determined by the determination section. Therefore, it is possible to save the effort of operating an operation section of the display device to input the information representing the installation condition of the irradiation device.

In the display device according to the aspect of the invention, the determination section may determine whether or not there exists another display device adapted to emit the detection light along the display surface as the installation condition of the irradiation device, and in a case in which it is determined by the determination section that there exists the another display device, the adjustment section may decrease the output of the detection light emitted by the irradiation device to a level lower than the output in a case in which it has been determined that the another display device fails to exist.

According to the aspect of the invention with this configuration, in the case in which there exists another display device for emitting the detection light, the output of the irradiation device is adjusted to a level lower than the output in the case in which the another display device does not exist. Therefore, it is possible to optimally adjust the output of the irradiation device to improve the detection accuracy of the pointing position.

In the display device according to the aspect of the invention, in a case in which the another display device exists, the determination section may determine a position of the another display device, and based on a determination result of the determination section, the adjustment section may decrease the output of the detection light emitted by the irradiation section located on a side near to the another display device out of the first irradiation section and the second irradiation section to a level lower than the output of the detection light emitted by the irradiation section located on a side far from the another display device.

According to the aspect of the invention with this configuration, the output of the detection light emitted by the irradiation section located on a side near to the another display device out of the first irradiation section and the second irradiation section is adjusted to a level lower than the output of the detection light emitted by the irradiation section located on a side far from the another display device. Therefore, it is possible to optimally adjust the output of the irradiation device to improve the detection accuracy of the pointing position.

In the display device according to the aspect of the invention, the determination section may determine whether or not a reflecting surface adapted to reflect the detection light emitted by the irradiation device exists within a detection range in which the detection section detects the detection light, and in a case in which it is determined by the determination section that there exists the reflecting surface, the adjustment section may decrease the output of the detection light emitted by the irradiation device to a level lower than the output in a case in which it has been determined that the reflecting surface fails to exist.

According to the aspect of the invention with this configuration, in the case in which there exists the reflecting surface within the detection range of the detection section, the output of the irradiation device is adjusted to a level lower than the output in the case in which the reflecting surface does not exist. Therefore, it is possible to optimally adjust the output of the irradiation device to improve the detection accuracy of the pointing position.

In the display device according to the aspect of the invention, in a case in which the reflecting surface exists, the determination section may determine a position of the reflecting surface, and based on a determination result of the determination section, the adjustment section may decrease the output of the detection light emitted by the irradiation section located on a side near to the reflecting surface out of the first irradiation section and the second irradiation section to a level lower than the output of the detection light emitted by the irradiation section located on a side far from the reflecting surface.

According to the aspect of the invention with this configuration, the output of the detection light emitted by the irradiation section located on a side near to the reflecting surface out of the first irradiation section and the second irradiation section is adjusted to a level lower than the output of the detection light emitted by the irradiation section located on a side far from the reflecting surface. Therefore, it is possible to optimally adjust the output of the irradiation device to improve the detection accuracy of the pointing position.

In the display device according to the aspect of the invention, the detection section may detect light intensity of the detection light reflected by a reflecting body disposed in a display area of the display surface, and the adjustment section may adjust the output of the detection light emitted by at least one of the first irradiation section and the second irradiation section based on light intensity of the detection light detected by the detection section.

According to the aspect of the invention with this configuration, it is possible to optimally adjust the output of the irradiation device to improve the detection accuracy of the pointing position.

In the display device according to the aspect of the invention, the adjustment section may make the display section display a display image showing a position at which the reflecting body is to be disposed in the display area.

According to the aspect of the invention with this configuration, it is possible to make the user easily and simply recognize the position at which the reflecting body is to be disposed.

In the display device according to the aspect of the invention, the adjustment section may make the display section display an image showing a position where light intensity of the detection light reflected by the reflecting body and detected by the detection section becomes equal to or lower than a threshold value as the display image.

According to the aspect of the invention with this configuration, there is displayed the image showing the position where the light intensity of the detection light to be detected becomes equal to or lower than the threshold value. Therefore, it is possible to prevent the light intensity of the detection light output by the irradiation device from falling below the light intensity necessary for detecting the pointing position in the entire display surface.

In the display device according to the aspect of the invention, the reflecting body may be a finger of a user or a jig.

According to the aspect of the invention with this configuration, it is possible to use a finger of the user or a jig as the reflecting body. In the case of using a jig as the reflecting body, it is possible to accurately detect the light intensity of the detection light reflected by the reflecting body, and in the case of using the finger of the user as the reflecting body, it is possible to easily detect the light intensity of the detection light thus reflected without additionally disposing the jig or the like.

In the display device according to the aspect of the invention, the adjustment section may adjust an emission direction of the detection light in a plane extending along the display surface.

According to the aspect of the invention with this configuration, it is possible to adjust the emission direction of the detection light in the plane extending along the display surface.

A method according to another aspect of the invention is a method of controlling a display device provided with a display section adapted to display an image on a display surface, and an irradiation device having a first irradiation section and a second irradiation section adapted to emit detection light along the display surface, the method including adjusting an output of the detection light emitted by at least one of the first irradiation section and the second irradiation section in accordance with an installation condition of the irradiation device, and detecting reflected light of the detection light emitted by at least one of the first irradiation section and the second irradiation section.

According to the aspect of the invention, the output of the detection light emitted by at least one of the first irradiation section and the second irradiation section is adjusted by the adjustment section in accordance with the installation condition of the irradiation device. Therefore, it is possible to optimally adjust the output of the irradiation device in accordance with the installation condition of the irradiation device to improve the detection accuracy of the pointing position.

### BRIEF DESCRIPTION OF THE DRAWINGS

The invention will be described with reference to the accompanying drawings, wherein like numbers reference like elements.

FIG. 1 is a diagram showing an installation condition of projectors.

FIG. 2 is a diagram showing an irradiation range with infrared light emitted by a light emission device.

FIG. 3 is a configuration diagram showing a configuration of one of the projectors.

FIG. 4 is a diagram showing an installation condition of the projectors.

FIG. 5 is a diagram showing an installation condition of the projector.

FIG. 6 is a diagram showing a reflecting body.

FIG. 7 is a diagram showing installation positions of the reflecting bodies.

FIG. 8 is a diagram showing an installation position of the reflecting body.

FIG. 9 is a flowchart showing an operation.

### DESCRIPTION OF AN EXEMPLARY EMBODIMENT

An embodiment of the invention will hereinafter be described with reference to the accompanying drawings.

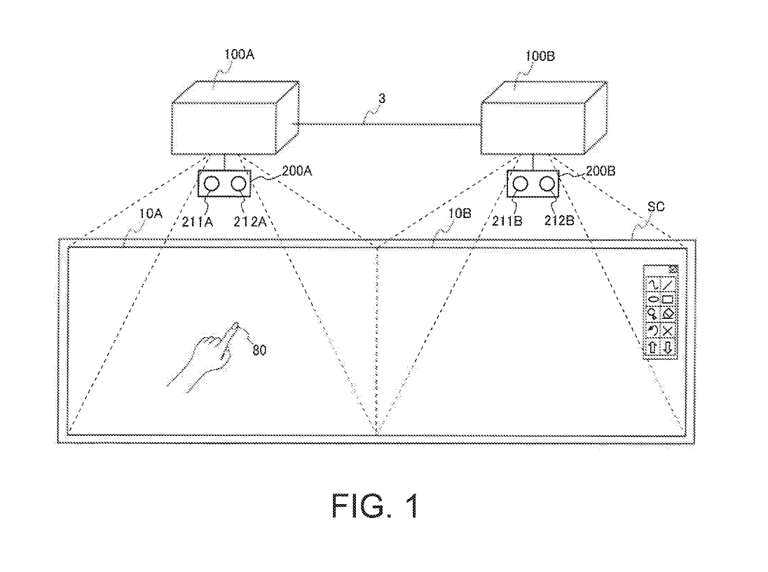

FIG. 1 is a diagram showing an installation condition of projectors 100.

The present embodiment has a configuration in which the two projectors 100 are disposed immediately above or obliquely above a screen SC as a display surface, and along a lateral direction of the screen SC. The projector 100 located on the left side when facing to the screen SC is described as a projector 100A, and the projector 100 located on the right side is described as a projector 100B. Further, in the following description, the projector 100A and the projector 100B are described as projectors 100 in the case of collectively describing them. In the present embodiment, there is described the case of projecting an image by two projectors 100, namely the projector 100A and the projector 100B, but the number of the projectors 100 is not limited to two, but can also be three or more.

The screen SC is a flat plate or a curtain fixed to the wall, or erected on the floor surface. The description is presented citing the case, in which the display surface is the screen SC, as an example in the present embodiment, but it is also possible to use the wall of a conference room, a classroom, or the like as the display surface without any modification. In the case of using the wall of a conference room, a classroom, or the like as the display surface, the projector 100 is installed on the upper part of the wall.

The area of the screen SC is divided into two areas, namely a projection area 10A on which the projector 100A projects an image and a projection area 10B on which the projector 100B projects an image. The projection area 10A is an area located on the left side when facing to the screen SC, and the projection area 10B is an area located on the right side when facing to the screen SC. The projection areas 10A, 10B each correspond to a “display area” according to the invention. It should be noted that the projection area 10A and the projection area 10B are each described as a projection area 10 unless there is a need for distinguishing them from each other.

The projectors 100A and 100B are connected to an image supply device not shown. As the connection between the projectors 100A and 100B and the image supply device, wired connection can be adopted, and wireless connection can also be adopted. To the projectors 100A and 100B, there is input image data supplied from the image supply device. The projectors 100A and 100B each perform image processing for correcting the luminance, the resolution, and so on the image data input to the projectors 100A and 100B, and then project the images based on the image data on which the image processing has been performed on the projection areas 10A, 10B of the screen, respectively.

Although the case in which the projectors 100A and 100B are connected to the same image supply device is described in the present embodiment, it is also possible to adopt a configuration in which the projector 100A and the projector 100B are connected to respective image supply devices separated from each other. Further, it is also possible to adopt a configuration in which either one of the projector 100A and the projector 100B projects the image based on the image data supplied from the image supply device on the screen SC.

The projector 100A is connected to a light emission device 200A, and the projector 100B is connected to a light emission device 200B. The present embodiment adopts a configuration in which the light emission devices 200A, 200B are exposed outside the projectors 100A and 100B, respectively, but it is also possible to dispose the light emission devices 200A, 200B inside the projectors 100A and 100B, respectively. The light emission devices 200A, 200B are devices for performing irradiation with the light (hereinafter referred to simply as infrared light) in the infrared frequency band along the screen SC. The infrared light corresponds to the “detection light” according to the invention.

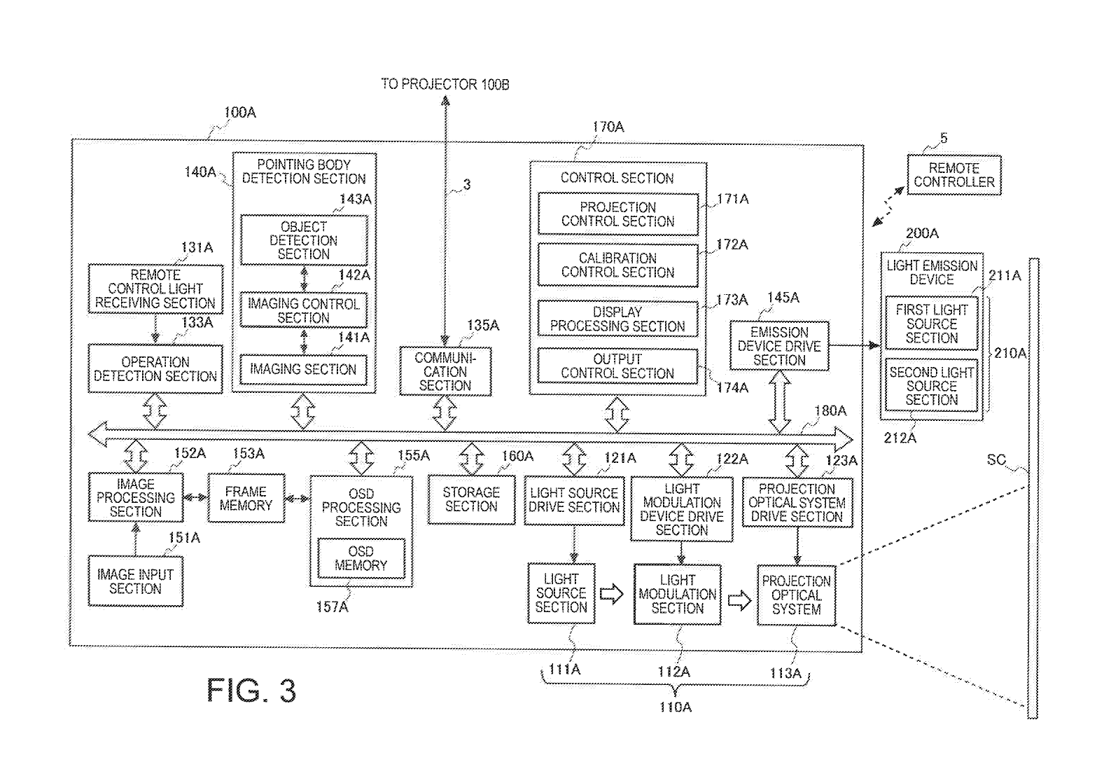

When the user makes a finger, a pointing rod, or the like (hereinafter referred to as a pointing body 80) touch or come closer to the screen SC, the infrared light emitted from the light emission device 200A or 200B reaches the pointing body 80 to be reflected by the pointing body 80. A part of the reflected light which has reached and has then been reflected by the pointing body 80 proceeds toward the projector 100A or 100B. The projectors 100A and 100B detect the reflected light having been reflected by the pointing body 80 using imaging sections 141A and 141B (see FIG. 3), respectively, to detect the position (hereinafter referred to as a pointing position) on the screen SC pointed by the pointing body 80.

The present embodiment has a configuration in which the reflected light of the infrared light is imaged to be detected by the imaging sections 141A and 141B of the respective projectors 100A and 100B installed above the screen SC. Therefore, it is desirable for the distance between the infrared light emitted by the light emission devices 200A and 200B and the screen SC to be a distance of, for example, about several millimeters.

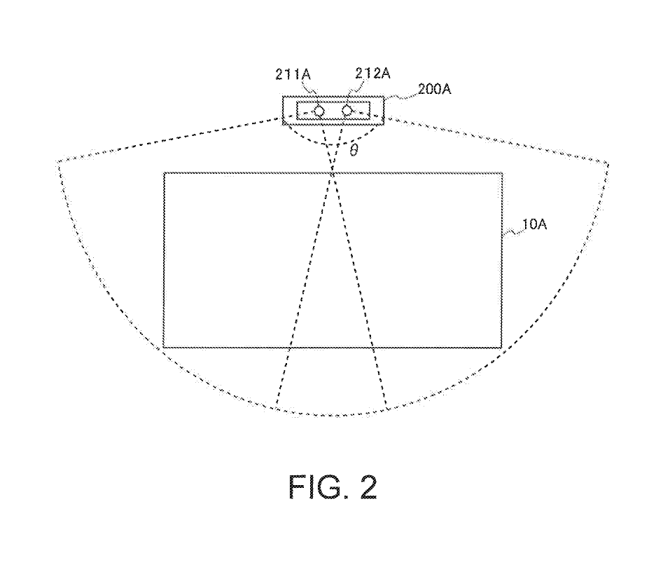

FIG. 2 is a diagram showing an irradiation range of the infrared light emitted by the light emission device 200A connected to the projector 100A.

The light emission devices 200A and 200B are each installed above the upper end of the screen SC to emit the infrared light downward to form a layer (hereinafter referred to as a light curtain) of the infrared light. The light emission device 200A is configured including a first light source section 211A, a second light source section 212A, an optical device (not shown), and so on housed in a box-like case. The light emission device 200A corresponds to an “irradiation device” according to the invention. Further, the first light source section 211A corresponds to a “first irradiation section” according to the invention, and the second light source section 212A corresponds to a “second irradiation section” according to the invention.

The first light source section 211A and the second light source section 212A are each a laser diode (LD) for emitting the infrared light. The first light source section 211A is installed on the left side when facing to the screen SC, and the second light source section 212A is installed on the right side when facing to the screen SC.

The optical device diffuses the light output from the first light source section 211A and the second light source section 212A along the screen SC to perform the irradiation. The angle θ (see FIG. 2) formed by the infrared light diffused by the optical device reaches roughly 180 degrees, and thus, roughly the entire projection area 10A is irradiated with the infrared light. The angle formed by the infrared light corresponds to the angle θ formed between the infrared light output from the first light source 211A and then diffused by the optical device toward the opposite side to the second light source section 212A, and the infrared light output from the second light source section 212A and then diffused by the optical device toward the opposite side to the first light source section 211A.

The optical device of the projectors 100A and 100B is provided with an adjustment mechanism (not shown) for adjusting the angle (the angle θ formed between the infrared light described above) of the diffusion of the infrared light.

The light emission device 200B is provided with roughly the same configuration as that of the light emission device 200A, and irradiates the projection area 10B with the infrared light.

FIG. 3 is a configuration diagram showing a configuration of the projector 100A. The projectors 100A and 100B are respectively provided with roughly the same configurations. Therefore, in the following description, the configuration of the projector 100A will be described as a representative of the projectors 100, and the description of the configuration of the projector 100B will be omitted. It should be noted that although the character “A” is attached at the foot of each of the reference numerals denoting the constituents of the projector 100A, it is assumed that in the case of denoting the constituents of the projector 100B, “B” is attached at the foot of each of the reference numerals. Further, in the case in which there is no need to distinguish between the constituents of the projector 100A and the constituents of the projector 100B from each other, the character “A” or “B” is not attached at the foot of each of the reference numerals.

The projector 100A is provided with an image input section 151A. The image input section 151A is connected to the image supply device with wire or wirelessly. In the following description, there will be described the case in which the image input section 151A is connected to the image supply device with a cable.

The image input section 151A is provided with a connector for connecting the cable and an interface circuit (both not shown). To the image input section 151A, there is input the image data supplied from the image supply device. The interface of the image input section 151A can be an interface for data communication, or can also be an interface for image communication. As the interface for data communication, there can be cited, for example, Ethernet (registered trademark), IEEE 1394, and USB. Further, as the interface for image communication, there can be cited, for example, MHL (registered trademark), HDMI (registered trademark), and DisplayPort.

Further, it is also possible for the image input section 151A to have a configuration provided with a VGA terminal to which an analog video signal is input, or a DVI (digital visual interface) terminal to which a digital video data is input as the connector. Further, the image input section 151A is provided with an A/D conversion circuit, and in the case in which the analog vide signal is input via the VGA terminal, the image input section 151A converts the analog video signal into digital image data with the A/D conversion circuit to output the result to an image processing section 152A described later.

The projector 100A is provided with a projection section 110A for performing formation of an optical image to project the image on the screen SC. The projection section 110A corresponds to a “display section” according to the invention. The projection section 110A is provided with a light source section 111A, a light modulation device 112A, and a projection optical system 113A.

The light source section 111A is provided with a light source formed of a xenon lamp, a super-high pressure mercury lamp, a light emitting diode (LED), a laser source, or the like. The light source section 111A can also be provided with a reflector and an auxiliary reflector for guiding the light emitted by the light source to the light modulation device 112A. The light source section 111A can be provided with a lens group for improving the optical characteristics of the projection light, a polarization plate, a dimming element for reducing the light intensity of the light emitted by the light source on a path leading to the light modulation device 112A, and so on (neither thereof shown).

The projector 100A is provided with a light source drive section 121A for driving the light source section 111A. The light source drive section 121A is connected to the light source section 111A and a bus 180A to control lighting and extinction of the light source section 111A in accordance with the control by a control section 170A also connected to the bus 180A.

The light modulation device 112A is provided with, for example, three liquid crystal panels corresponding respectively to the three primary colors of RGB. The light emitted by the light source section 111A is separated into colored light beams of three colors of RGB to enter the corresponding liquid crystal panels. The three liquid crystal panels are each a transmissive liquid crystal panel, and modulate the light beams transmitted through the liquid crystal panels to generate the image light beams. The image light beams of the respective colors, which have been modulated while passing through the respective liquid crystal panels, are combined by a combining optical system such as a cross dichroic prism, and are then output to the projection optical system 113A.

The projector 100A is provided with a light modulation device drive section 122A for driving the light modulation device 112A. The light modulation device drive section 122A is connected to the light modulation device 112A and the bus 180A, and operates in accordance with the control by the control section 170A.

The light modulation device drive section 122A generates each of the image signals of R, G, and B based on the display image data input from an OSD processing section 155A. Based on the image signals of R, G, and B thus generated, the light modulation device drive section 122A drives the corresponding liquid crystal panels of the light modulation device 112A to draw the images on the respective liquid crystal panels.

The projection optical system 113A is provided with a projection lens (not shown) for projecting the image light, which has been modulated by the light modulation device 112A, toward the screen SC to form the image on the screen SC. The projection lens is a zoom lens having a function of performing an adjustment of the field angle, namely an adjustment (zoom adjustment) of the size of the image to be projected. Further, the projection lens also has a function of adjusting (performing a focus adjustment) the focal position.

The projector 100A is provided with a projection optical system drive section 123A for driving the projection optical system 113A. The projection optical system drive section 123A is connected to the projection optical system 113A and the bus 180A, and adjusts the lens position of the projection lens to perform the zoom adjustment and the focus adjustment in accordance with the control by the control section 170A.

The projector 100A is provided with a remote control light receiving section 131A and an operation detection section 133A, and receives an operation on the remote controller 5. The operation detection section 133A is connected to the remote control light receiving section 131A and the bus 180A.

The remote controller 5 is provided with a plurality of operation buttons for operating the projector 100A to transmits an infrared signal corresponding to the operation button having been operated. The remote control light receiving section 131A receives the infrared signal transmitted from the remote controller 5. The operation detection section 133A decodes the infrared signal received by the remote control light receiving section 131A to generate a signal (hereinafter referred to as an operation signal) representing the operation content received by the remote controller 5, and then outputs the operation signal to the control section 170A via the bus 180A.

Further, the remote controller 5 is provided with a switching button as one of the operation buttons described above. When the switching button is operated, the projector 100 to be operable by the remote controller 5 is switched between the projector 100A and the projector 100B.

The projector 100A is provided with a communication section 135A. The communication section 135A is connected to the bus 180A.

The communication section 135A is a wired interface for performing the data communication, and is connected to a communication line 3. The communication section 135A transmits and receives a variety of types of data with the projector 100B via the communication line 3 in accordance with the control by the control section 170A.

Although in the present embodiment, there is described the case in which the communication section 135A is the wired interface, the communication section 135A can also be a wireless interface for performing wireless communication such as Wireless LAN or Bluetooth (registered trademark). In this case, a part or the whole of the communication line 3 is constituted by a wireless communication line.

The projector 100A is provided with an emission device drive section 145A, the light emission device 200A, and a pointing body detection section 140A. The emission device drive section 145A, the light emission device 200A, and the pointing body detection section 140A are used for detecting an operation to the screen SC. The emission device drive section 145A and the pointing body detection section 140A are connected to the bus 180A. The pointing body detection section 140A corresponds to a “detection section” according to the invention.

The emission device drive section 145A is connected to the light emission device 200A, and drives the light emission device 200A. The emission device drive section 145A generates a pulse signal in accordance with the control by the control section 170A, and then outputs the pulse signal thus generated to the light emission device 200A. Lighting and extinction of the first light source section 211A and the second light source section 212A are controlled by the pulse signal input from the emission device drive section 145A. The control section 170A controls the emission device drive section 145A to light the first light source section 211A and the second light source section 212A in sync with the timing at which the imaging section 141A described later performs imaging.

Further, the emission device drive section 145A controls the electrical power to be supplied to the light emission device 200A in accordance with the control by the control section 170A. For example, it is assumed that the light intensity of the infrared light output by the first light source section 211A is made lower than the light intensity of the infrared light output by the second light source section 212A. In this case, the control section 170A controls the emission device drive section 145A so that the electrical power to be supplied to the first light source section 211A becomes lower than the electrical power to be supplied to the second light source section 212A.

The pointing body detection section 140A is provided with the imaging section 141A, an imaging control section 142A, and an object detection section 143A to detect an operation by the pointing body 80 to the screen SC.

The imaging section 141A is incorporated in the projector 100A installed above the screen SC. The imaging section 141A has an imaging optical system, an imaging element, an interface circuit, and so on, and images the projection direction of the projection optical system 113A.

The imaging optical system constitutes an imaging lens for forming a subject image on a light receiving surface of the imaging element. The imaging range of the imaging optical system is a range including the projection area 10A and the periphery of the projection area 10A. The imaging range corresponds to a “detection range” according to the invention. The imaging element converts the subject image formed on the light receiving surface into an electrical image signal, and then outputs the image signal to the interface circuit. As the imaging element, there is used a CCD (charge coupled device) or a CMOS (complementary metal oxide semiconductor) for receiving light in the infrared region or the visible light region. The interface circuit performs a predetermined process on the image signal input from the imaging element to convert the image signal into a digital signal. The interface circuit outputs the image signal thus converted to the imaging control section 142A as taken image data.

Further, the imaging section 141A can also be provided with a filter for shielding a part of the light entering the imaging element. For example, in the case of making the imaging element receive the infrared light, the filter mainly transmitting the light in the infrared region is disposed in front of the imaging element.

The imaging control section 142A makes the imaging section 141A perform imaging to form the taken image data. When the imaging section 141A performs the imaging with the visible light, the image projected on the screen SC is imaged. Further, when the imaging section 141A performs the imaging with the infrared light, the reflected light of the infrared light reflected by the pointing body 80 is imaged.

The object detection section 143A inputs the taken image data from the imaging control section 142A, and then detects the image of the reflected light imaged in the taken image data thus input. The image of the reflected light is an image of the reflected light of the infrared light, which has been emitted from the light emission device 200A, and then reached to be reflected by the pointing body 80.

Further, the object detection section 143A detects the coordinate representing the position of the image of the reflected light thus detected. The coordinate detected by the object detection section 143A is a coordinate representing the position on the taken image data defining an arbitrary position (e.g., the upper left position) set in advance, for example, as an origin. The object detection section 143A outputs the coordinate thus detected to the control section 170A as coordinate information.

The projector 100A is provided with an image processing system. The image processing system is constituted by the control section 170A for performing overall control of the whole of the projector 100A as a central constituent, and is provided with the image processing section 152A, a frame memory 153A, an OSD (on-screen display) processing section 155A, and a storage section 160A besides the control section 170A. The control section 170A, the image processing section 152A, the OSD processing section 155A, and the storage section 160A are connected to the bus 180A so as to be able to perform data communication with each other.

The image processing section 152A develops the image data input from the image input section 151A in the frame memory 153A in accordance with the control by the control section 170A. The image processing section 152A performs image processing such as a resolution conversion (scaling) process, a resizing process, correction of a distortion aberration, a shape correction process, a digital zoom process, a tint adjustment process, and a luminance adjustment process on the image data developed in the frame memory 153A. The image processing section 152A performs the process designated by the control section 170A, and performs the process using a parameter input from the control section 170A as needed. Further, it is obviously possible for the image processing section 152A to perform two or more of the processes described above in combination with each other.

The OSD processing section 155A is provided with an OSD memory 157A. The OSD memory 157A stores graphic data (e.g., data of a graphic displayed as a tool bar), a font, and so on as object image data. The OSD processing section 155A superimposes the object image data on the image data developed in the frame memory 153A in accordance with the instruction of the control section 170A. The OSD processing section 155A retrieves the image data on which the object image data is superimposed from the frame memory 153A, and then outputs the image data to the light modulation device drive section 122A as the display image data. Further, in the case in which the superimposing instruction of the image data is not provided from the control section 170A, the OSD processing section 155A retrieves the image data from the frame memory 153A, and then outputs the image data to the light modulation device drive section 122A as the display image data.

The storage section 160A stores a control program such as an application program executed by the CPU of the control section 170A. Further, the storage section 160A stores a variety of parameters used by the image processing section 152A for the image processing, and calibration image data used for the calibration described later.

The control section 170A is provided with a CPU, a ROM, and a RAM (neither thereof shown) as the hardware. The ROM is a nonvolatile storage device such as a flash ROM, and stores a control program such as an OS (an operating system) and data. The RAM is used as a working area for the CPU. The CPU develops the control program, which has been retrieved from the ROM or the storage section 160A, in the RAM, and then executes the control program thus developed to control each section of the projector 100A.

Further, the control section 170A is provided with a projection control section 171A, a calibration control section 172A, a display processing section 173A, and an output control section 174A as functional blocks. These functional blocks are realized by the CPU executing the control program stored in the ROM or the storage section 160A. The output control section 174A corresponds to an “adjustment section” and a “determination section” according to the invention.

The control section 171A controls the constituents of the projector 100A to project the image on the screen SC. Specifically, the projection control section 171A makes the image processing section 152A perform the image processing to the image data. On this occasion, it is also possible for the projection control section 171A to retrieve the parameter which is necessary for the image processing section 152A to perform the image processing from the storage section 160A and pass the parameter to the image processing section 152A. Further, the projection control section 171A controls the light source drive section 121A to light the light source of the light source section 111A and then control the luminance of the light source. Further, the projection control section 171A controls the light modulation device drive section 122A to draw the images based on the display image data on the liquid crystal panels of the light modulation device 112A. Further, the projection control section 171A controls the projection optical system drive section 123A to adjust the lens position of the projection lens to perform the zoom adjustment and the focus adjustment.

The calibration control section 172A performs a calibration for identifying the pointing position pointed by the pointing body 80. The calibration is, for example, a process for making a position (coordinate) on the frame memory 153A and a position (coordinate) on the taken image data obtained by imaging the projection area 10A correspond to each other. The taken image data is the taken image data taken by the imaging section 141A. Since the position on the frame memory 153A and the position on the taken image data are made to correspond to each other, it is possible to identify an image displayed at the pointing position on the projection area 10A pointed by the pointing body 80, and to project an image designated by the user at the pointing position.

The calibration control section 172A retrieves, for example, calibration image data having marks with a shape set in advance arranged at predetermined intervals from the storage section 160A. The calibration control section 172A controls the projection section 110A to project the calibration image in the projection area 10A on the screen SC.

Then, the calibration control section 172A controls the pointing body detection section 140A to make the imaging section 141A perform imaging to obtain the taken image data from the imaging control section 142A. The calibration control section 172A detects the marks imaged in the taken image data thus obtained to obtain the centroid position of each of the marks as the coordinate value of the mark. This coordinate is the coordinate representing, for example, the position on the taken image data defining the upper left of the taken image data as the origin.

Then, the calibration control section 172A makes correspondence between the coordinate of the mark detected from the taken image data and the coordinate of the mark of the calibration image data developed in the frame memory 153A. By making the correspondence, the calibration control section 172A generates calibration data for making the correspondence between the coordinate on the taken image data and the coordinate on the frame memory 153A.

Further, the calibration control section 172A determines the sizes in the vertical direction and the horizontal direction of the projection area 10A based on the execution result of the calibration.

Regarding the determination of the size of the projection area 10A, the determination is performed based on the result of the correspondence between the coordinate of the mark detected from the taken image data and the coordinate of the mark of the calibration image data developed in the frame memory 153A.

To the display processing section 173A, there is input the coordinate information from the pointing body detection section 140A. The coordinate represented by the coordinate information is the coordinate representing the position on the taken image data. The display processing section 173A converts the coordinate represented by the coordinate information thus input into the coordinate on the frame memory 153A using the calibration data. The display processing section 173A performs a drawing process for drawing the image in the projection area 10A based on the coordinate on the frame memory 153A thus converted. For example, the display processing section 173A controls the OSD processing section 155A to draw a character, a figure, a sign or the like at the coordinate on the frame memory 153A thus converted.

The output control section 174A controls the emission device drive section 145A to switch the signal level of the pulse signal supplied by the emission device drive section 145A to the light emission device 200A to a high level or a low level. The infrared light output by the light emission device 200A is switched ON or OFF in accordance with the change in the signal level of the pulse signal.

Further, the output control section 174A determines the installation condition of the light emission device 200A. The output control section 174A controls the emission device drive section 145A in accordance with the installation condition of the light emission device 200A thus determined to control the electrical power to be supplied to the first light source section 211A and the second light source section 212A. Thus, the output of the infrared light emitted by at least either one of the first light source section 211A and the second light source section 212A is controlled. For example, by making the electrical power supplied to the first light source section 211A lower than the electrical power supplied to the second light source section 212A, the light intensity of the infrared light output by the first light source section 211A becomes lower than the light intensity of the infrared light output by the second light source section 212A.

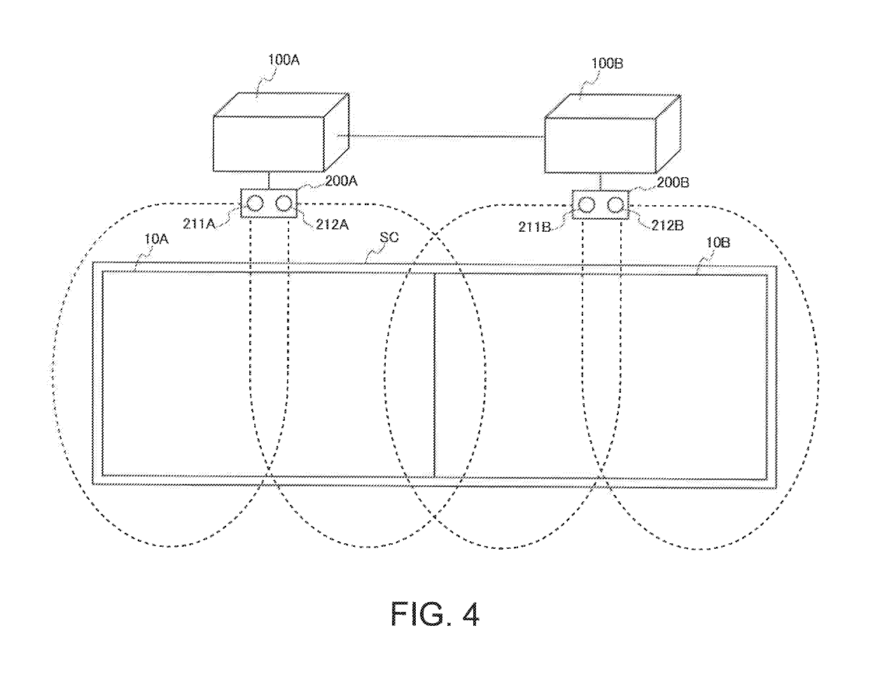

FIG. 4 is a diagram showing an installation condition of the projectors 100A and 100B.

In the present embodiment, the light emission devices 200A and 200B are installed immediately below the projectors 100A and 100B, respectively. Therefore, the installation condition of the light emission devices 200A and 200B can also be rephrased as the installation condition of the projectors 100A and 100B. Therefore, in the following description, the installation condition of the light emission devices 200A and 200B can also be referred to as the installation condition of the projectors 100A and 100B.

As the installation condition of the light emission device 200A determined by the output control section 174A, the following conditions can be cited. Firstly, as a first installation condition, there can be cited the case in which the two projectors 100A and 100B are arranged side by side in the horizontal direction as shown in FIG. 4. Specifically, in the case shown in FIG. 4, the light emission device 200A and the light emission device 200B are installed close to each other, and a part of the infrared light emitted by the light emission device 200A and a part of the infrared light emitted by the light emission device 200B overlap each other. FIG. 4 shows the case in which a part of the infrared light emitted by the second light source section 212A of the light emission device 200A and a part of the infrared light emitted by the first light source section 211B of the light emission device 200B overlap each other. The light intensity in the area where the infrared light emitted by one of the two light emission devices 200A, 200B and the infrared light emitted by the other thereof overlap each other becomes higher than the light intensity in the area where the overlap of the infrared light does not occur. In order to detect the pointing position of the pointing body 80 from the taken image data of the imaging section 141A or 141B, it is necessary to make the light intensity of the infrared light, irradiation with which is performed along the projection areas 10A and 10B for detecting the pointing position, equal to or higher than a certain light intensity. However, if the light intensity is higher than the light intensity necessary for the detection of the pointing position, the infrared light reflected by the pointing body 80 excessively spreads, which is not preferable from the viewpoint of an improvement in detection accuracy. Therefore, the output control section 174A controls the emission device drive section 145A based on the installation condition of the light emission device 200A thus determined to control the electrical power to be supplied to the first light source section 211A and the second light source section 212A. In the case of the installation condition of the light emission device 200A shown in FIG. 4, the output control section 174A controls the emission device drive section 145A so as to decrease the output of the second light source section 212A to a level lower than the output of the first light source section 211A.

Further, the output control section 174A instructs the projector 100B to decrease the output of the infrared light output by the light emission device 200B. The projector 100B is capable of determining the installation condition of the light emission device 200B similarly to the projector 100A. When receiving the instruction from the projector 100A, the output control section 174B of the projector 100B controls the emission device drive section 145B to decrease the output of the first light source section 211B to a level lower than the output of the second light source section 212B based on the installation condition of the light emission device 200B thus determined.

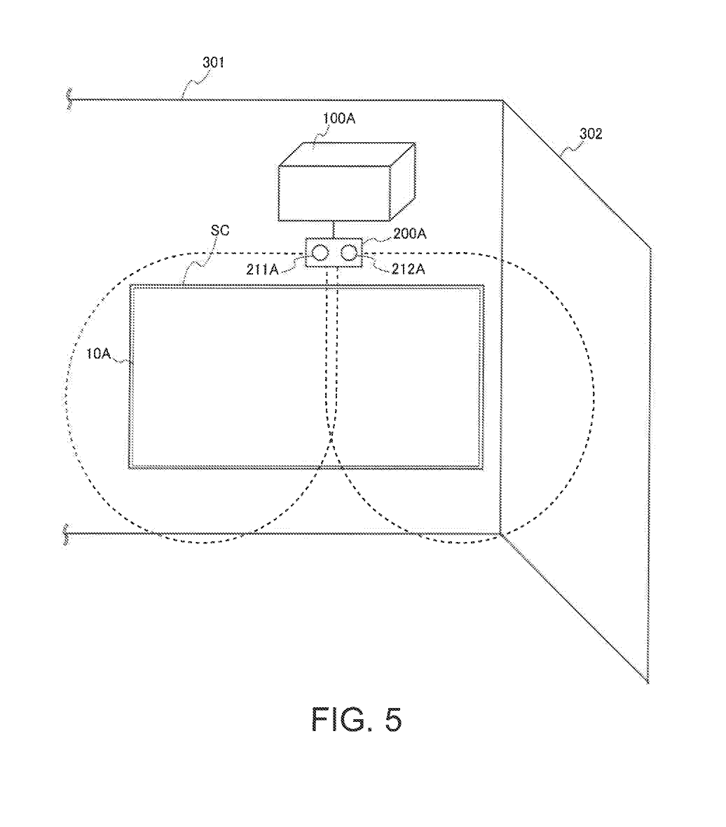

FIG. 5 is a diagram showing the installation condition of the projector 100A.

As a second installation condition, there can be cited the case of installing the projector 100 in the vicinity of a corner part (a corner) of a room such as a conference room or a classroom. FIG. 5 shows the case of installing the projector 100A as the projector 100. A wall to which the projector 100A is installed is described as a wall 301, and a wall constituting the corner part in the room together with the wall 301 is described as a wall 302. In the case of installing the projector 100A in the vicinity of the corner part of the room, the distance between the projector 100A and the wall 302 becomes short as shown in FIG. 5. Therefore, a part of the infrared light emitted by the light emission device 200A is reflected by the wall 302, and then returns toward the direction of the projection area 10A. Therefore, in the case of pointing some areas of the projection area 10A with the pointing body 80, the reflected light of the infrared light having been reflected by the wall 302 and then having returned toward the direction of the projection area 10A, and the reflected light of the infrared light emitted by the light emission device 200A are detected. Therefore, similarly to the first installation condition shown in FIG. 4, the light intensity of the infrared light necessary for the detection of the pointing position becomes an excessive light intensity, which is not preferable from the viewpoint of an improvement in detection accuracy. Therefore, the output control section 174A controls the emission device drive section 145A based on the installation condition of the light emission device 200A thus determined to control the electrical power to be supplied to the first light source section 211A and the second light source section 212A. In the case of the installation condition of the light emission device 200A shown in FIG. 5, the output control section 174A controls the emission device drive section 145A so as to decrease the output of the second light source section 212A to a level lower than the output of the first light source section 211A.

Then, the determination method for the output control section 174A to determine the installation condition of the light emission device 200A will be described. For example, the output control section 174A determines the installation condition of the light emission device 200A based on the operation received by the remote controller 5. Specifically, the user operates the remote controller 5 to make the projector 100A recognize the installation condition of the light emission device 200A. Similarly, the user operates the remote controller 5 to make the projector 100B recognize the installation condition of the light emission device 200B.

The installation condition of the light emission device 200A determined by the output control section 174A includes four patterns, namely a first pattern through a fourth pattern described below.

The first pattern and the second pattern are each a pattern in which the projector 100A is installed together with the other projector 100B so as to be arranged laterally side by side. The first pattern is a pattern in which the projector 100B as the other projector 100 is installed on the right side of the projector 100A as the target projector 100. Since the operation of the output control section 174A is described here, the projector 100A becomes the target projector 100. In the situation in which the projectors 100A and 100B are installed so as to be arranged laterally side by side, the installation condition of the projector 100A corresponds to the first pattern.

The second pattern is a pattern in which the projector 100B as the other projector 100 is installed on the left side of the projector 100A as the target projector 100. In the case in which the projector 100B is assumed as the target projector 100 in FIG. 4, the installation condition of the projector 100B corresponds to the second pattern.

The third pattern and the fourth pattern are each a pattern in which the projector 100A is installed alone. The third pattern is a pattern in which the wall exists on the right side of the projector 100A. The installation condition shown in FIG. 5 shows the case corresponding to the third pattern. Further, the fourth pattern is a pattern in which the wall exists on the left side of the projector 100A.

When the remote controller 5 is operated, and the operation signal representing the installation condition of the light emission device 200A is input from the operation detection section 133A, the output control section 174A adjusts the output of at least one of the first light source section 211A and the second light source section 212A.

In the case in which the operation signal representing the first pattern has been input from the operation detection section 133A, the output control section 174A adjusts the electrical power to be supplied to the second light source section 212A so that the output of the second light source section 212A becomes lower than the output of the first light source section 211A. In the case of the first pattern, the infrared light output by the second light source section 212A overlaps the infrared light output by the first light source section 211B of the projector 100B. Therefore, the output control section 174A controls the emission device drive section 145A to adjust the electrical power to be supplied to the second light source section 212A so as to be lower than the electrical power to be supplied to the first light source section 211A as much as a value set in advance. Thus, the light intensity of the infrared light output by the second light source section 212A becomes lower than the light intensity of the infrared light output by the first light source section 211A.

Further, in the case in which the operation signal representing the second pattern has been input from the operation detection section 133A, the output control section 174A adjusts the electrical power to be supplied to the first light source section 211A so that the output of the first light source section 211A becomes lower than the output of the second light source section 212A. In the case of the second pattern, the infrared light output by the first light source section 211A overlaps the infrared light output by the second light source section 212B of the projector 100B. Therefore, the output control section 174A controls the emission device drive section 145A to adjust the electrical power to be supplied to the first light source section 211A so as to be lower than the electrical power to be supplied to the second light source section 212A as much as a value set in advance. Thus, the light intensity of the infrared light output by the first light source section 211A becomes lower than the light intensity of the infrared light output by the second light source section 212A.

Further, in the case in which the operation signal representing the third pattern has been input from the operation detection section 133A, the output control section 174A adjusts the electrical power to be supplied to the second light source section 212A so that the output of the second light source section 212A becomes lower than the output of the first light source section 211A. In the case of the third pattern, the infrared light output by the second light source section 212A is reflected by the wall, and then returns toward the direction of the projection area 10A of the screen SC. Therefore, the output control section 174A controls the emission device drive section 145A to adjust the electrical power to be supplied to the second light source section 212A so as to be lower than the electrical power to be supplied to the first light source section 211A as much as a value set in advance. Thus, the light intensity of the infrared light output by the second light source section 212A becomes lower than the light intensity of the infrared light output by the first light source section 211A.

Further, in the case in which the operation signal representing the fourth pattern has been input from the operation detection section 133A, the output control section 174A adjusts the electrical power to be supplied to the first light source section 211A so that the output of the first light source section 211A becomes lower than the output of the second light source section 212A. In the case of the fourth pattern, the infrared light output by the first light source section 211A is reflected by the wall, and then returns toward the direction of the projection area 10A of the screen SC. Therefore, the output control section 174A controls the emission device drive section 145A to adjust the electrical power to be supplied to the first light source section 211A so as to be lower than the electrical power to be supplied to the second light source section 212A as much as a value set in advance. Thus, the light intensity of the infrared light output by the first light source section 211A becomes lower than the light intensity of the infrared light output by the second light source section 212A.

Further, it is also possible for the output control section 174A to determine which one of the first pattern through the fourth pattern the installation condition of the projector 100A corresponds to based on the taken image data of the imaging section 141A.

For example, the output control section 174A performs communication with the projector 100B to transmit the output instruction of the infrared light to the projector 100B. The projector 100B having received the output instruction from the projector 100A drives the light emission device 200B to output the infrared light. On this occasion, the projector 100B controls the light emission device 200B so that the angle θ (see FIG. 2) formed by the infrared light diffused by the optical device of the light emission device 200B becomes the maximum. Thus, it is arranged that the infrared light output by the light emission device 200B is imaged by the imaging section 141A of the projector 100A installed on the left side or the right side of the projector 100B.

The output control section 174A transmits the output instruction of the infrared light to the projector 100B, and then makes the imaging section 141A perform imaging. The output control section 174A obtains the taken image data, and then detects the area where the infrared light emitted by the light emission device 200B is imaged from the taken image data thus obtained. The output control section 174A determines the installation condition of the projector 100A based on the area of the taken image data obtained by imaging the infrared light thus detected. Specifically, in the case in which the infrared light output by the light emission device 200B is imaged in the left side area of the taken image data, the output control section 174A determines that the projector 100B is installed on the left side of the projector 100A. Further, in the case in which the infrared light output by the light emission device 200B is imaged in the right side area of the taken image data, the output control section 174A determines that the projector 100B is installed on the right side of the projector 100A.

When the output control section 174A has determined the installation condition of the projectors 100A and 100B, the output control section 174A transmits the information (hereinafter referred to as installation information) representing the installation condition thus determined to the projector 100B. The installation information is the information representing which one of the first pattern and the second pattern the installation condition of the projector corresponds to.

Further, the output control section 174A determines whether or not the wall is imaged in the taken image data of the visible light taken by the imaging section 141A to determine whether or not the installation condition of the projector 100A is one of the third pattern and the fourth pattern.

For example, the output control section 174A first identifies the floor and the ceiling imaged in the taken image data, and then determines an area which has the area equal to or larger than a certain value, is located between the floor and the ceiling thus identified, and has a single color as the wall. Then, the output control section 174A determines whether the installation condition of the projector 100A corresponds to the third pattern, or corresponds to the fourth pattern based on the position in the taken image data of the area determined as the wall.

Further, in the case in which the imaging section 141A of the projector 100A is capable of imaging not only the projection area 10A but also a part of the projection area 10B as the imaging range, it is also possible for the projector 100A to instruct the projector 100B to project the image. The projector 100B having received the projection instruction of the image projects an image in which the pattern image set in advance in the projection area 10B. By imaging this pattern image with the imaging section 141A, the projector 100A can determine the layout of the projector 100A and the projector 100B.

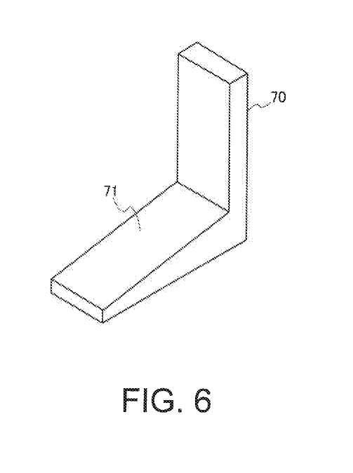

FIG. 6 is a diagram showing a configuration of a reflecting body 70.

The output control section 174A determines the installation condition of the light emission device 200A, and then based on the installation condition thus determined, the output control section 174A determines the position on the projection area 10A at which the reflecting body 70 is to be disposed. The reflecting body 70 is a member having an L-shape for reflecting the light emitted by the light emission device 200A. The reflecting body 70 has a reflecting surface 71. The reflecting surface 71 is formed using a material for reflecting the infrared light emitted by the light emission device 200A, and is formed of, for example, plastic. Further, the reflecting body 70 can detachably attached to the screen SC with a magnet, an adhesive disc, a two-sided adhesive tape, or the like, but can also be supported by a human hand or the like.

Further, although in the present embodiment, there is described the case of using a jig as the reflecting body 70, it is also possible to use a finger (the pointing body 80) of the user as the reflecting body 70.

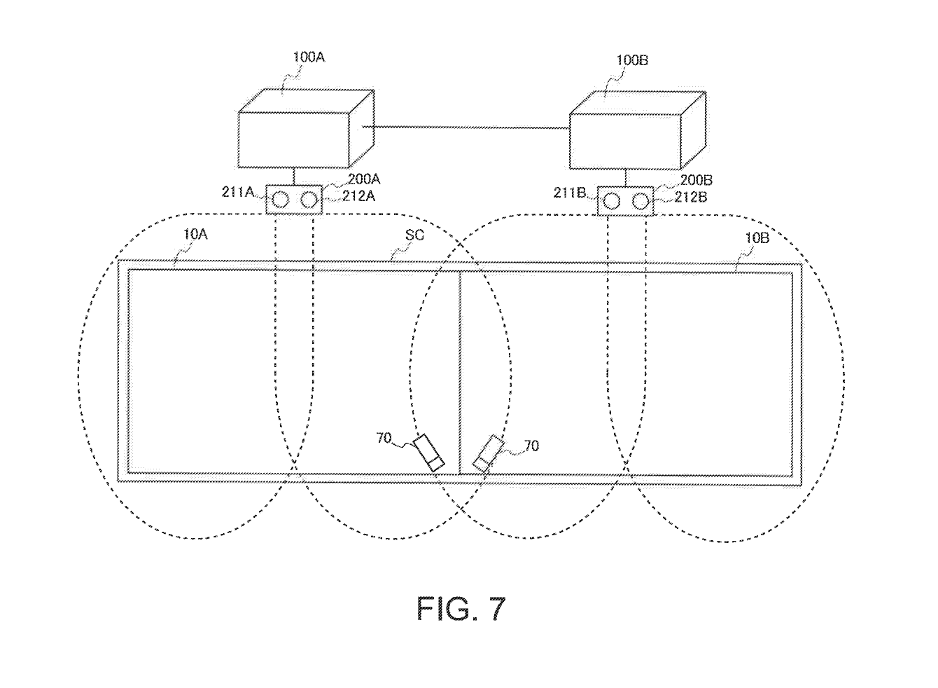

FIG. 7 is a diagram showing a position on the projection area 10A at which the reflecting body 70 is disposed.

In the case in which it has been determined that the installation condition of the light emission device 200A is the first pattern, the output control section 174A instructs the user to dispose the reflecting body 70 at the lower right end of the projection area 10A when facing to the screen SC. Specifically, the output control section 174A instructs the user to dispose the reflecting body 70 in the area where the infrared light emitted by the second light source section 212A of the light emission device 200A and the infrared light emitted by the first light source section 211B of the light emission device 200B overlap each other. The instruction of the position at which the reflecting body 70 is to be disposed is performed by, for example, the output control section 174A displaying a predetermined image in the projection area 10A. The output control section 174A displays an image (hereinafter referred to as a layout image), in which a rectangular image representing the projection area 10A and an image including a mark or a symbol attached to the position where the reflecting body 70 is disposed are displayed, in the projection area 10A.

Further, in the case in which it has been determined that the installation condition of the projector 100A is the second pattern, the output control section 174A instructs the user to dispose the reflecting body 70 at the lower left end of the projection area 10A when facing to the screen SC.

The position at which the reflecting body 70 is to be disposed on the projection area 10A is changed in accordance with the first pattern through the fourth pattern. The position at which the reflecting body 70 is to be disposed is a position in the projection area 10A at which the light intensity of the infrared light emitted from the light emission device 200 is lower than that of the rest of the area, and is equal to or lower than a threshold value set in advance. If the light intensity of the infrared light at this position is equal to or higher than a reference value, the light intensity of the infrared light detected at other positions of the projection area 10A also becomes equal to or higher than the reference value. It is advisable that the position has been measured for each of the first pattern through the fourth pattern in advance, and then stored in the storage section 160A as the position information.

Further, in the case in which the output control section 174A has determined that the installation condition of the light emission device 200A is the first pattern or the second pattern, the output control section 174A notifies the projector 100B of the installation condition of the light emission device 200B. Specifically, in the case in which the output control section 174A has determined that the installation condition of the light emission device 200A is the first pattern, the output control section 174A notifies the projector 100B of the fact that the installation condition of the light emission device 200B is the second pattern. Further, in the case in which the output control section 174A has determined that the installation condition of the light emission device 200A is the second pattern, the output control section 174A notifies the projector 100B of the fact that the installation condition of the light emission device 200B is the first pattern. Although in the present embodiment, there is described the case in which the projector 100A acts as a master unit, the projector 100 acting as the master unit can be the projector 100A, or can also be the projector 100B.

When the output control section 174B of the projector 100B receives the notification of the installation condition of the light emission device 200B from the projector 100A, the output control section 174B displays the predetermined image in the projection area 10B to instruct the position at which the reflecting body 70 is to be disposed.

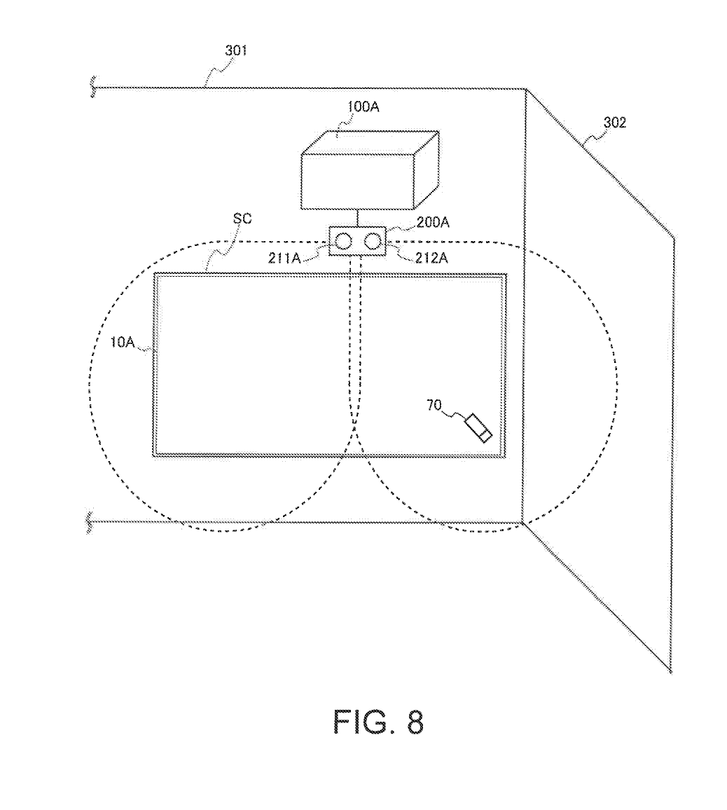

FIG. 8 is a diagram showing the layout position of the reflecting body 70 in the case in which the projector 100 has been installed close to the wall.

In the case in which the output control section 174A has determined that the installation condition of the light emission device 200A is the third pattern, namely the wall is located on the right side of the projector 100, the output control section 174A instructs the user to dispose the reflecting body 70 at the lower right end of the projection area 10A, namely the lower end part on the wall side of the projection area 10A.

The output control section 174A displays the layout image as described above.

Further, in the case in which the output control section 174A has determined that the installation condition is the fourth pattern, namely the wall is located on the left side of the projector 100, the output control section 174A instructs the user to dispose the reflecting body 70 at the lower left end of the projection area 10A, namely the lower end part on the wall side of the projection area 10A.

When the image for instructing the user to dispose the reflecting body 70 is displayed in the projection area 10A, the user disposes the reflecting body 70 at the position shown in the image. Further, when the image for instructing the user to dispose the reflecting body 70 is displayed in the projection area 10B, the user disposes the reflecting body 70 at the position shown in the image.

The user disposes the reflecting body 70, and then operates the remote controller 5 to notify the projector 100A of the fact that the arrangement of the reflecting body 70 has been completed. Similarly, the user operates the remote controller 5 to notify the projector 100B of the fact that the arrangement of the reflecting body 70 has been completed.

In the case in which the operation signal has been input from the operation detection section 133A, and the operation signal is a signal representing the fact that the arrangement of the reflecting body 70 has been completed, the output control section 174A controls the emission device drive section 145A to make the light emission device 200A emit the infrared light. Further, in the case in which the installation condition of the projectors 100A and 100B is the first pattern or the second pattern, the output control section 174A transmits the output instruction of the infrared light to the projector 100B.

When the infrared light is emitted from the light emission devices 200A and 200B, the reflecting body 70 disposed in the projection area 10A reflects the infrared light emitted from these light emission devices 200A and 200B. Similarly, when the infrared light is emitted from the light emission devices 200A and 200B, the reflecting body 70 disposed in the projection area 10B reflects the infrared light emitted from these light emission devices 200A and 200B.

The output control section 174A makes the imaging element of the imaging section 141A receive the infrared light having been reflected by the reflecting body 70, and then determines the light intensity of the infrared light at the position at which the reflecting body 70 is disposed based on the intensity of the light received by the imaging element.

The output control section 174A compares the intensity of the light received by the imaging element and the reference value set in advance with each other to determine whether or not the light intensity of the infrared light output by the first light source section 211A or the second light source section 212A is adjusted. In the case in which the installation condition of the light emission device 200A is the first pattern, the output control section 174A determines whether or not the light intensity of the infrared light output by the second light source section 212A is adjusted. Further, in the case in which the installation condition of the light emission device 200A is the second pattern, the output control section 174A determines whether or not the light intensity of the infrared light output by the first light source section 211A is adjusted.

The output control section 174A obtains the difference between the intensity of the light received by the imaging element and the reference value set in advance. The output control section 174A determines whether or not the output of the first light source section 211A or the second light source section 212A is to be decreased based on the difference thus obtained. In the case in which the output control section 174A has determined that the intensity of the light received by the imaging element is equal to or higher than the reference value set in advance, and the difference between the intensity of the light received and the reference value is smaller than the threshold value, the output control section 174A determines that the output of the light emission device 200A is not to be decreased. Further, in the case in which the output control section 174A has determined that the intensity of the light received by the imaging element is equal to or higher than the reference value, and the difference between the intensity of the light received and the reference value is equal to or larger than the threshold value, the output control section 174A decreases the light intensity of the infrared light output by the first light source section 211A or the second light source section 212A as much as a certain amount.

Further, in the case of decreasing the output of the light emission device 200A, the output control section 174A controls the emission device drive section 145A to decrease the output of either one of the first light source section 211A and the second light source section 212A as much as a certain amount. The output control section 174A decreases the output of the light emission device 200A as much as the certain amount, and then obtains the difference between the intensity of the light received by the imaging element of the imaging section 141A and the reference value set in advance once again to determine whether or not the output of the first light source section 211A or the second light source section 212A is to be decreased. The output control section 174A repeats the operation described hereinabove until the intensity of the infrared light received by the imaging element is equal to or higher than the reference value set in advance, and the difference between the intensity of the light received and the reference value becomes smaller than the threshold value.

Further, the light emission device 200A can also be provided with a rotary mechanism. The rotary mechanism is a mechanism for rotating at least one of a set of the first light source section 211A and the optical device for diffusing the infrared light output by the first light source section 211A, and a set of the second light source section 212A and the optical device for diffusing the infrared light output by the second light source section 212A.

Due to the control by the control section 170A, the emission device drive section 145A rotates at least one of the set of the first light source section 211A and the optical device and the set of the second light source section 212A and the optical device to adjust the emission direction of the infrared light in a plane extending along the screen SC. For example, in the case in which the output control section 174A has determined that the installation condition of the light emission device 200A is the first pattern shown in FIG. 4, the output control section 174A rotates the second light source section 212A and the optical device to adjust the emission direction of the infrared light. The output control section 174A rotates the second light source section 212A and the optical device to adjust the emission direction of the infrared light so as not to spread in a direction toward the projection area 10B. Further, also in the case in which the output control section 174A has determined that the installation condition of the light emission device 200A is the third pattern shown in FIG. 5, the output control section 174A rotates the second light source section 212A and the optical device to adjust the emission direction of the infrared light so as not to spread toward the wall 302.

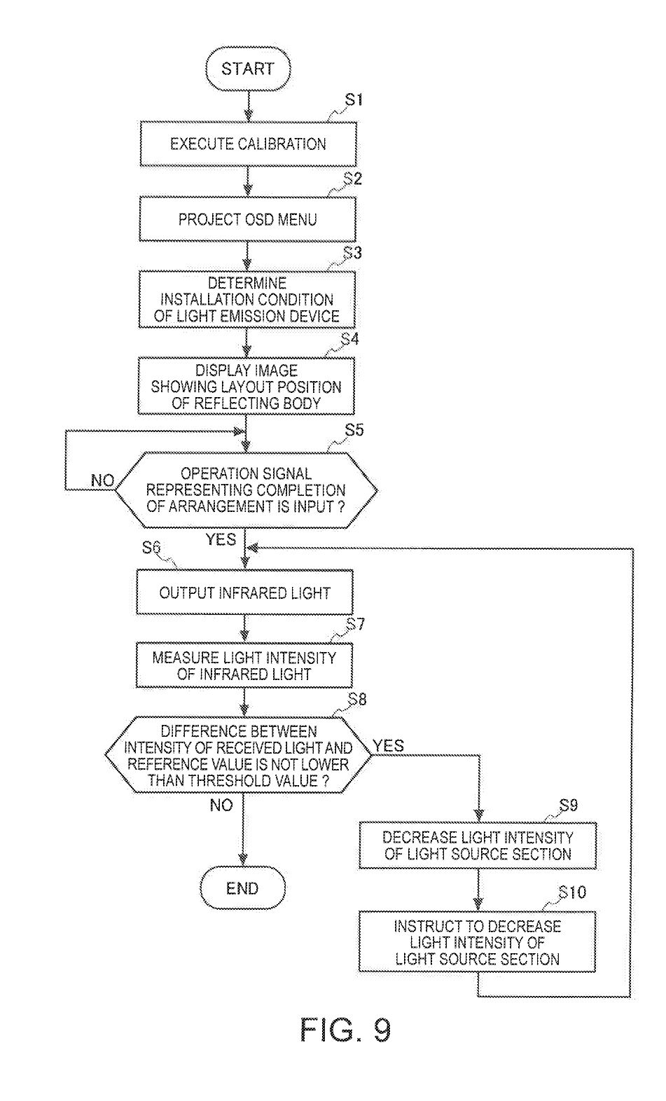

FIG. 9 is a flowchart showing the operation of the projector 100A. In this flowchart, there is described the case in which the installation condition of the projectors 100A and 100B is the first pattern or the second pattern. Further, there is described the case in which the projector 100A acts as the master unit, and instructs the projector 100B as the slave unit to adjust the light intensity of the infrared light.

When the projector 100A is powered ON, the projector 100A performs (step S1) the calibration to generate the calibration data. In this generation process of the calibration data, the projector 100A determines the sizes in the vertical direction and the horizontal direction of the projection area 10A. Similarly to the projector 100A, when the projector 100B is powered ON, the projector 100B performs the calibration to generate the calibration data to determine the sizes in the vertical direction and the horizontal direction of the projection area 10B.

Then, the control section 170A projects (step S2) the OSD menu on the screen SC. The OSD menu is a menu screen in which selection items for selecting the operation to be performed by the projector 100A are displayed, and the output adjustment of the light emission devices 200A and 200B is included as the selection item. The display of the OSD menu is an operation performed only by the projector 100A as the master unit.

In the case in which the output adjustment of the light emission devices 200A and 200B has been selected as the OSD menu, the control section 170A determines (step S3) the installation condition of the light emission device 200A. The determination of the installation condition can also be determined in accordance with the operation signal transmitted from the remote controller 5 as described above. Further, it is also possible for the control section 170A to communicate with the projector 100B to make the light emission device 200B of the projector 100B emit the infrared light, and image the infrared light with the imaging section 141A to detect the installation condition of the projector 100A.

The control section 170A as the master unit determines the installation condition of the light emission device 200A and the light emission device 200B. In the case in which the control section 170A has determined that the installation condition of the light emission device 200A and the light emission device 200B corresponds to the first pattern or the second pattern, the control section 170A transmits the installation information representing the installation condition of the light emission device 200B.

Then, the control section 170A instructs (step S4) the user to dispose the reflecting body 70 at the position in the projection area 10A corresponding to the installation condition of the light emission device 200A thus determined. For example, the control section 170A displays the layout image in the projection area 10A to perform the instruction to the user.

Then, the control section 170A determines (step S5) whether or not the operation signal representing the fact that the arrangement of the reflecting body 70 to the projection area 10A has been completed has been input from the operation detection section 133A. In the case in which the operation signal is not input (NO in the step S5), the control section 170A waits until the operation signal is input. Further, in the case in which the operation signal has been input (YES in the step S5), the control section 170A controls the emission device drive section 145A to drive the first light source section 211A and the second light source section 212A to output (step S6) the infrared signal. On this occasion, the control section 170A controls the emission device drive section 145A so that the output of the light emission device 200A becomes the output corresponding to the size of the projection area 10A determined in the calibration. The output corresponding to the size of the projection area 10A denotes the output set so that the intensity of the light received by the imaging element of the imaging section 141A becomes equal to or higher than the reference value set in advance in the entire area of the projection area 10A. For example, in the storage section 160A, there are stored the size of the projection area 10A and the output of the light emission device 200A so as to correspond to each other.

The control section 170A controls the emission device drive section 145A to make the first light source section 211A and the second light source section 212A of the light emission device 200A output the infrared light, and then makes the imaging element of the imaging section 141A measure (step S7) the light intensity of the infrared light. Then, the control section 170A determines the light intensity of the infrared light at the position at which the reflecting body 70 is disposed based on the intensity of the light received by the imaging element. The control section 170A compares the intensity of the light received by the imaging element and the reference value with each other to determine the light intensity of the infrared light at the position at which the reflecting body 70 is disposed. The control section 170A obtains the difference between the intensity of the light received by the imaging element and the reference value, and then compares (step S8) the difference thus obtained with the threshold value. In the case in which the control section 170A has determined that the difference between the intensity of the light received and the reference value is equal to or larger than the threshold value (YES in the step S8), the control section 170A decreases (step S9) the light intensity of the infrared light of either one of the first light source section 211A and the second light source section 212A as much as a certain amount in accordance with the installation condition determined in the step S3. Further, in the case in which the installation condition of the light emission device 200A is the first pattern or the second pattern, the control section 170A instructs (step S10) the projector 100B to decrease the light intensity of the infrared light output by the light emission device 200B as much as a certain amount. The control section 170B of the projector 100B which has received the instruction from the projector 100A decreases the light intensity of the infrared light output by either one of the first light source section 211B and the second light source section 212B as much as a certain amount in accordance with the installation condition of the light emission device 200B thus determined. Further, in the case (NO in the step S8) in which the difference between the intensity of the light received and the reference value is smaller than the threshold value, the control section 170A terminates the processing flow.

In this processing flow, in the case in which the installation condition of the light emission devices 200A and 200B corresponds to the first pattern and the second pattern, the reflecting bodies 70 are disposed at the positions in the projection areas 10A and 10B corresponding to the pattern thus determined to adjust the output of the light emission devices 200A and 200B. Besides the above, in the case in which the projector 100A has determined that the installation condition of the light emission device 200A corresponds to the first pattern or the second pattern, it is also possible for the projector 100A to decrease the output of the first light source section 211A or the second light source section 212A as much as a certain amount in accordance with the pattern thus determined. In other words, it is also possible to arrange that the output of the first light source section 211A or the second light source section 212A is decreased as much as the light intensity set in advance without performing the process of measuring the light intensity of the infrared light, which is reflected by the reflecting body 70 using the reflecting body 70, using the imaging section 141.

Further, in the case in which the projector 100A has determined that the installation condition of the light emission device 200A corresponds to the third pattern or the fourth pattern, it is also possible for the projector 100A to decrease the output of the first light source section 211A or the second light source section 212A as much as a certain amount in accordance with the pattern thus determined. Specifically, in the case in which the output control section 174 has determined that the wall exists in the vicinity of the projector 10, it is also possible for the output control section 174 to decrease the output of the light source section located closer to the wall out of the first light source section 211A and the second light source section 212A as much as a certain amount.

As described hereinabove, the projector 100 according to the present embodiment is provided with the projection section 110, the light emission device 200, the pointing body detection section 140, and the output control section 174.

The projection section 110 projects the image on the screen SC. The light emission device 200 is provided with the first light source section 211 and the second light source section 212 for emitting the infrared light along the screen SC. The pointing body detection section 140 detects the reflected light of the infrared light emitted by at least one of the first light source section 211 and the second light source section 212. The output control section 174 adjusts the output of the infrared light emitted by at least one of the first light source section 211 and the second light source section 212 in accordance with the installation condition of the light emission device 200.

Therefore, it is possible to optimally adjust the output of the light emission device 200 in accordance with the installation condition of the light emission device 200 to improve the detection accuracy of the pointing position.

Further, the output control section 174 determines the installation condition of the light emission device 200. The output control section 174 adjusts the output of the infrared light emitted by at least one of the first light source section 211 and the second light source section 212 in accordance with the installation condition of the light emission device 200 thus determined.

Therefore, it is possible to save the effort of operating the remote controller 5 to input the information representing the installation condition of the light emission device 200.

Further, the output control section 174 determines whether or not there exists another projector 100 for emitting the infrared light along the screen SC as the installation condition of the light emission device 200. In the case in which it has been determined that there exists another projector 100, the output control section 174 decreases the output of the infrared light emitted by the light emission device 200 to a level lower than the output in the case in which it has been determined that there exists no other projector 100.

Therefore, it is possible to optimally adjust the output of the light emission device 200 to improve the detection accuracy of the pointing position. Further, since the output of the infrared light is decreased, it becomes possible to reduce the power consumption of the display device.

Further, in the case in which there exists another projector 100, the output control section 174 determines the position of the another projector 100. Based on the determination result, the output control section 174 decreases the output of the infrared light emitted by the light source section located on the side near to the another projector 100 out of the first light source section 211 and the second light source section 212 to a level lower than the output of the infrared light emitted by the light source section located on the side far from the another projector 100.

Therefore, it is possible to optimally adjust the output of the light emission device 200 to improve the detection accuracy of the pointing position. Further, since the output of the infrared light is decreased, it becomes possible to reduce the power consumption of the display device.

Further, the output control section 174 determines whether or not the wall 302 for reflecting the infrared light emitted by the light emission device 200 exists in the detection range in which the pointing body detection section 140 detects the infrared light. The wall 302 corresponds to a “reflecting surface” according to the invention. In the case in which the output control section 174 has determined that there exists the wall, the output control section 174 decreases the output of the infrared light emitted by the light emission device 200 to a level lower than the output in the case in which it has been determined that the wall 302 does not exist.

Therefore, it is possible to optimally adjust the output of the light emission device 200 to improve the detection accuracy of the pointing position. Further, since the output of the infrared light is decreased, it becomes possible to reduce the power consumption of the display device.

Further, in the case in which there exists the wall 302, the output control section 174 determines the position of the wall 302.

Based on the determination result, the output control section 174 decreases the output of the infrared light emitted by the light source section located on the side near to the wall 302 out of the first light source section 211 and the second light source section 212 to a level lower than the output of the infrared light emitted by the light source section located on the side far from the wall.

Therefore, it is possible to optimally adjust the output of the light emission device 200 to improve the detection accuracy of the pointing position. Further, since the output of the infrared light is decreased, it becomes possible to reduce the power consumption of the display device.

Further, the imaging section 141 detects the light intensity of the infrared light reflected by the reflecting body 70 disposed in the projection area 10A or 10B of the screen SC. The output control section 174 adjusts the output of the infrared light emitted by at least one of the first light source section 211 and the second light source section 212 based on the light intensity of the infrared light detected.

Therefore, it is possible to optimally adjust the output of the light emission device 200 to improve the detection accuracy of the pointing position.

Further, the output control section 174 makes the projection section 110 display the display image representing the position at which the reflecting body 70 is to be disposed in the projection area 10.

Therefore, it is possible to make the user easily and simply recognize the position at which the reflecting body 70 is to be disposed.

Further, the output control section 174 displays the image representing the position where the light intensity of the infrared light reflected by the reflecting body 70 and then detected by the pointing body detection section 140 becomes equal to or lower than the threshold value, as a display image.

Therefore, it is possible to prevent the light intensity of the infrared light output by the light emission device 200 from falling below the light intensity necessary for detecting the pointing position in the entire screen SC.

Further, the reflecting body 70 is the pointing body 80 as a finger of the user or a jig.

In the case of using a jig as the reflecting body 70, it is possible to accurately detect the light intensity of the infrared light reflected by the reflecting body 70, and in the case of using the pointing body 80 as the reflecting body, it is possible to easily detect the light intensity of the infrared light without additionally disposing the jig or the like.

Further, the output control section 174 adjusts the emission direction of the infrared light in a plane extending along the screen SC. Therefore, it is possible to adjust the emission direction of the infrared light in the plane extending along the screen SC.

The embodiment described above is a preferred embodiment of the invention. It should be noted that the invention is not limited to the embodiment, but can be implemented with a variety of modifications within the scope or the spirit of the invention.

For example, although in the embodiment described above, the description is presented assuming the projectors 100A and 100B as the liquid crystal projectors using the transmissive liquid crystal panels, the projector using a reflective liquid crystal panels or digital mirror device can also be adopted.

Further, each of the functional sections of the projector 100A shown in FIG. 3 is for showing the functional configuration realized by the cooperation of hardware and software, and the specific installation configuration is not particularly limited. Therefore, it is not necessarily required to install the hardware corresponding individually to each of the functional sections, but it is obviously possible to adopt a configuration of realizing the functions of the plurality of functional sections by a single processor executing a program. Further, apart of the function realized by software in the embodiment described above can also be realized by hardware, or a part of the function realized by hardware can also be realized by software.

Further, the processing unit of the flowchart shown in FIG. 9 is obtained by dividing the process of the control section 170 in accordance with major processing contents in order to make the process of the control section 170 easy to understand. The scope of the invention is not limited by the way of the division or the names of the processing units shown in the flowcharts of FIG. 9. Further, the process of the control section 170 can also be divided into a larger number of processing units, or can also be divided so that one processing unit includes a larger amount of process in accordance with the processing contents. Further, the processing procedure of the flowchart described above is not limited to the example shown in the drawing.

The entire disclosure of Japanese Patent Application No. 2017-081133, filed Apr. 17, 2017 is expressly incorporated by reference herein.

What is claimed is:

1. A display device comprising:
a display section adapted to display an image on a display surface;
an irradiation device provided with a first irradiation section and a second irradiation section each emitting detection light along the display surface;
a detection section adapted to detect reflected light of the detection light emitted by at least one of the first irradiation section and the second irradiation section; and
an adjustment section adapted to adjust an output of the detection light emitted by at least one of the first irradiation section and the second irradiation section in accordance with an installation condition of the irradiation device.

2. The display device according to claim 1, further comprising:
a determination section adapted to determine the installation condition of the irradiation device,
wherein the adjustment section adjusts the output of the detection light emitted by at least one of the first irradiation section and the second irradiation section in accordance with the installation condition of the irradiation device determined by the determination section.

3. The display device according to claim 2, wherein
the determination section determines whether or not there exists another display device adapted to emit the detection light along the display surface as the installation condition of the irradiation device, and
in a case in which it is determined by the determination section that there exists the another projector, the adjustment section decreases the output of the detection light emitted by the irradiation device to a level lower than the output in a case in which it has been determined that the another display device fails to exist.

4. The display device according to claim 3, wherein
in a case in which the another display device exists, the determination section determines a position of the another display device, and
based on a determination result of the determination section, the adjustment section decreases the output of the detection light emitted by the irradiation section located on a side near to the another display device out of the first irradiation section and the second irradiation section to a level lower than the output of the detection light emitted by the irradiation section located on a side far from the another display device.

5. The display device according to claim 2, wherein
the determination section determines whether or not a reflecting surface adapted to reflect the detection light emitted by the irradiation device exists within a detection range in which the detection section detects the detection light, and
in a case in which it is determined by the determination section that there exists the reflecting surface, the adjustment section decreases the output of the detection light emitted by the irradiation device to a level lower than the output in a case in which it has been determined that the reflecting surface fails to exist.

6. The display device according to claim 5, wherein
in a case in which the reflecting surface exists, the determination section determines a position of the reflecting surface, and
based on a determination result of the determination section, the adjustment section decreases the output of the detection light emitted by the irradiation section located on a side near to the reflecting surface out of the first irradiation section and the second irradiation section to a level lower than the output of the detection light emitted by the irradiation section located on a side far from the reflecting surface.

7. The display device according to claim 1, wherein
the detection section detects light intensity of the detection light reflected by a reflecting body disposed in a display area of the display surface, and
the adjustment section adjusts the output of the detection light emitted by at least one of the first irradiation section and the second irradiation section based on light intensity of the detection light detected by the detection section.

8. The display device according to claim 7, wherein
the adjustment section makes the display section display a display image showing a position at which the reflecting body is to be disposed in the display area.

9. The display device according to claim 8, wherein
the adjustment section makes the display section display an image showing a position where light intensity of the detection light reflected by the reflecting body and detected by the detection section becomes equal to or lower than a threshold value as the display image.

10. The display device according to claim 7, wherein
the reflecting body is a finger of a user or a jig.

11. The display device according to claim 1, wherein
the adjustment section adjusts an emission direction of the detection light in a plane extending along the display surface.

12. A method of controlling a display device provided with a display section adapted to display an image on a display surface, and an irradiation device having a first irradiation section and a second irradiation section adapted to emit detection light along the display surface, the method comprising:
adjusting an output of the detection light emitted by at least one of the first irradiation section and the second irradiation section in accordance with an installation condition of the irradiation device; and
detecting reflected light of the detection light emitted by at least one of the first irradiation section and the second irradiation section.
